(19) United States
(12) Patent Application Publication
(10) Pub. No.: US 2015/0249572 A1
(43) Pub. Date: Sep. 3, 2015

(54) Software-Defined Network Control Using Functional Objects

(71) Applicant: Futurewei Technologies, Inc., Plano, TX (US)

(72) Inventors: Thomas Benjamin Mack-Crane, Downers Grove, IL (US); Maarten Vissers, Huizen (NL); Young Lee, Plano, TX (US)

(21) Appl. No.: 14/635,535

(22) Filed: Mar. 2, 2015

Related U.S. Application Data
(60) Provisional application No. 61/947,245, filed on Mar. 3, 2014.

(51) Int. Cl. H04L 12/24; H04L 12/813

(52) U.S. Cl. CPC H04L 41/0806; H04L 47/20

(57) ABSTRACT

A method implemented in a network element (NE), comprising receiving a flow configuration message identifying a flow context in a software-defined network (SDN) and a network control associated with the flow context, wherein the flow configuration message comprises a function object (FO) reference that identifies the network control, generating an FO based on the FO reference, wherein the FO comprises a plurality of network behaviors associated with the network control, and performing the network control for the flow context based on the FO generated by the NE.

### CROSS-REFERENCE TO RELATED APPLICATIONS

The present application claims priority to U.S. Provisional Patent Application 61/947,245, filed Mar. 3, 2014 by T. Benjamin Mack-Crane, et. al., and entitled “Software Defined Network Control Using Functional Objects,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Software-defined networks (SDNs) have emerged as a promising technology. In SDNs, network control is decoupled from forwarding and is programmable, for example, by separating the control plane from the data plane and implementing the control plane using software applications and a centralized SDN controller, which may make routing decisions and communicate the routing decisions to all the network devices on the network. This migration from tightly bound individual network device control to control using accessible computing devices has enabled the underlying infrastructure to be abstracted for applications and network services, permitting treatment of the network as a logical entity. Open application programming interfaces (APIs), such as OpenFlow as described in the “OpenFlow switch specification version 1.4.0,” Oct. 14, 2013, which is incorporated herein by reference, may standardize the interactions between the data plane and the control plane, and thus allowing network devices and network controllers running different vendor firmware to communicate with each other.

### SUMMARY

In one embodiment, the disclosure includes a method implemented in a network element (NE), comprising receiving a flow configuration message identifying a flow context in an SDN and a network control associated with the flow context, wherein the flow configuration message comprises a function object (FO) reference that identifies the network control, generating an FO based on the FO reference, wherein the FO comprises a plurality of network behaviors associated with the network control, and performing the network control for the flow context based on the FO generated by the NE.

In another embodiment, the disclosure includes a computer program product comprising computer executable instructions stored on a non-transitory computer readable medium such that when executed by a processor causes an NE, positioned in an SDN to receive a flow configuration message from a network controller, wherein the flow configuration message comprises a flow entry that identifies a flow context in the SDN, and wherein the flow entry comprises a function object identifier (FOID) and a function object type (FOT) that identifies a network control associated with the flow context, add the flow entry to a flow table, wherein adding the flow entry to the flow table causes an implicit instantiation of an FO based on the FOID and the FOT, wherein the FO comprises a plurality of network function attributes for performing the network control, and wherein the FOID identifies the FO, and perform the network control for the flow context based on the FO generated by the NE.

In yet another embodiment, the disclosure includes an NE comprising a receiver configured to receive a flow configuration message from a network controller, wherein the flow configuration message comprises a flow entry that identifies a flow context in the SDN and a network control associated with the flow context, and wherein the flow entry comprises an FO reference associated with the network control, a memory coupled to the receiver and configured to store a flow table, and a processor coupled to the memory and the receiver and configured to update the flow table with the flow entry, generate an FO for the FO reference based on the network control when the flow entry is updated, wherein the FO comprises a plurality of network behaviors associated with the network control, and perform the network control for the flow context based on the FO generated by the NE. These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of an SDN-based system.

FIG. 2 is a schematic diagram of an embodiment of an OpenFlow network.

FIG. 3 is a schematic diagram of an embodiment of an NE acting as a node in an SDN.

FIG. 4 is a schematic diagram of an embodiment of a flow table entry for performing a connectivity fault management (CFM) loopback (LB) function in an SDN.

FIG. 5 is a schematic diagram of another embodiment of a flow table entry for performing a CFM LB function in an SDN.

FIG. 6 is a schematic diagram of an embodiment of a flow table entry for performing a CFM continuity check (CC) function in an SDN.

FIG. 7 is a schematic diagram of an embodiment of a flow table entry that employs an FO reference for performing CFM functions in an SDN.

FIG. 8 is a schematic diagram of an embodiment of a flow table entry that employs an FO reference for performing protection switching functions in an SDN.

FIG. 9 is a flowchart of an embodiment of a method for performing network control in an SDN.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Although the combination of the SDN model and the OpenFlow protocol enables network customization and optimization through software programmable control plane and data forwarding plane, the transportation of data from source nodes to destination nodes across multiple network nodes involves complex network controls in addition to making routing decisions for forwarding data packets in an SDN. For example, conventional Ethernet switches implement various complex network controls, such as operations, administration, and management (OAM) and protection switching, to enable network operators and/or network providers to resolve network problems, monitor network performances, and perform network maintenance.

One approach to providing complex network controls in an SDN may be to perform the complex controls centrally at network controllers. For example, to perform OAM in an SDN, network nodes may forward OAM packets, quality of service (QoS) packets, and/or other network management layer packets to one or more centralized network controllers. The centralized network controllers may in turn evaluate and analyze the packets, determine the appropriate actions, and instruct the network nodes to perform the actions. However, the amount of traffic between the network controllers and the network nodes may increase and the interactions between the network controllers and the network nodes may be complex. Thus, this approach may introduce control complexity into the SDN, and thus may not be efficient.

Another approach to providing complex network controls in an SDN may be to apply similar mechanisms as the SDN control of the data forwarding plane, where network controllers configure network nodes to perform the complex network controls. For example, to perform OAM in an SDN, network controllers may configure OAM flow tables in network nodes, where the OAM flow tables identify OAM flows in the SDN and the associated OAM actions. When the network nodes receive OAM packets, QoS packets, and/or other management layer packets from the OAM flows, the network nodes may perform the OAM actions corresponding to the OAM flows as instructed by the network controllers. However, the OAM flows and the OAM actions may be complex and some OAM actions may be independent from the OAM flow pipeline processing, for example, based on timers. Thus, this approach may lead to a large number of flow entries and complex matching rules, and thus may not be efficient.

Disclosed herein are embodiments for performing complex well-defined network controls in an SDN by extending the SDN model and the OpenFlow protocol. The disclosed embodiments employ network controllers to configure network nodes to perform complex network controls by specifying references to function objects (FOs). The FOs are also known as autonomous functions (AFs). An FO is an encapsulation of a set of well-defined network behaviors, for example, based on a standard protocol or any other well-defined network function definition. The set of well-defined network behaviors may be implemented as a patterned match-action table (MAT), a set of function attributes, and/or function implementations. Since the set of network behaviors are well-defined, FOs of the same network control type may be locally generated at different network nodes to produce the same network behaviors. For example, a network controller defines a matching rule for identifying a flow context in an SDN, determines a network control for the flow context, and configures the matching rule and the network control in a network node to enable the network node to perform the network control for the flow context. However, the network controller indicates the network control in the form of an FO reference instead of specifying the processing and the actions for performing the network control. Upon receiving the configuration of the matching rule and the FO reference, the network node generates an FO based on the FO reference such that the network node produces the network behaviors of the network control when the FO is executed by the network node. In an embodiment, the network controller configures the matching rule and the network control in the network node in the form of a MAT entry, which may be substantially similar to the OpenFlow protocol flow entry. The MAT entry comprises a match attribute comprising the matching rule and an action attribute comprising the FO reference. The FO reference may comprise an FO identifier (FOID) and an FO type (FOT). The FOT specifies the network control and the FOID is employed for identifying the FO that implements the network behaviors of the network control. The FO may be referenced by multiple action attributes. The FO may include internal states, which may be read and/or modified by referencing the FOID. The FO may comprise network behaviors that are independent from the flow pipeline processing, for example, triggered by timers. The FO may be implicitly deleted when all MAT entries referencing the FO are removed. The disclosed embodiments are compatible with the SDN model in which a network controller determines the network control associated with a flow context, but enable network nodes to generate the actions for the network control. Thus, the disclosed embodiments provide efficient SDN control for performing complex well-defined network controls. The present disclosure describes the employment of FOs for performing complex network controls in the context of CFM and protection switching, but the disclosed mechanisms are applicable to other types of complex well-defined network controls.

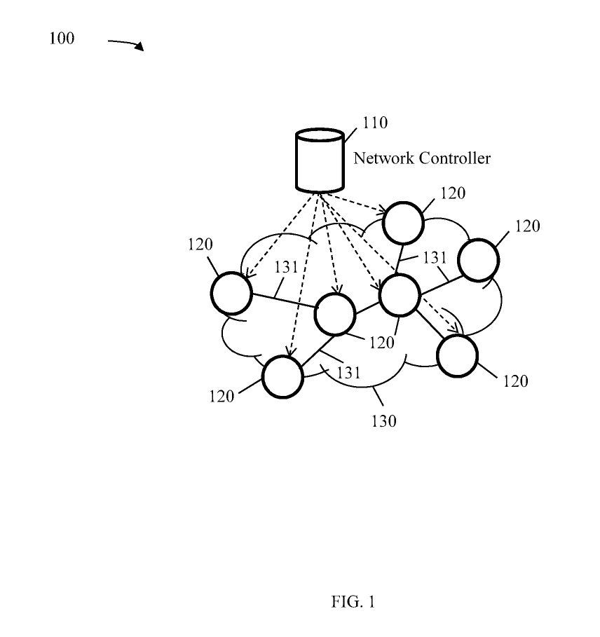

FIG. 1 is a schematic diagram of an embodiment of an SDN-based system 100. The system 100 comprises a transport network 130 coupled to a network controller 110. The network 130 comprises a plurality of network nodes 120 interconnected by a plurality of links 131. The network 130 may comprise a single networking domain or multiple networking domains. In an embodiment of a large SDN-based system, the system 100 may be partitioned into multiple network domains and each network domain may be coupled to a network controller 110. In another embodiment, the system 100 may comprise a single network domain coupled to multiple network controllers 110. The links 131 may comprise physical links, such as fiber optic links and/or electrical links, logical links, and or combinations thereof used to transport data.

The network controller 110 may be a virtual machine (VM), a hypervisor, or any other device configured to manage the network 130. The network controller 110 may be a software agent operating on hardware and acting on behalf of a network provider that owns the network 130. The network controller 110 is configured to define and manage data flows that occur in the data plane of the network 130. The network controller 110 maintains a full topology view of the underlying infrastructure of the network 130, computes forwarding paths through the network 130, and configures the network nodes 120 along the forwarding paths with forwarding instructions. The forwarding instructions may include a next network node 120 in a data flow in which data is to be forwarded to the next network node 120 and/or actions that are to be performed for the data flow. The network controller 110 sends the forwarding instructions to the network nodes 120 via the control plane (shown as dotted line) of the network 130. In an embodiment, the network controller 110 may provide the forwarding instructions in the form of flow tables or flow table entries.

The network nodes 120 may be switches, routers, bridges, and/or any other network devices suitable for forwarding data in the network 130. The network nodes 120 are configured to receive forwarding instructions from the network controller 110 via the control plane. Based on the forwarding instructions, a network node 120 may forward an incoming packet to a next network node 120 or drop the packet. Alternatively, when receiving a packet from an unknown flow or a particular flow that is determined to be handled by the network controller 110, the network nodes 120 may forward the packet to the network controller 110, which may in turn determine a forwarding path for the packet. A well-defined controller-switch communication protocol may be defined between the network controller 110 and the network nodes 120 to enable the network controller 110 and the network nodes 120 to communicate independent from the different vendor firmware deployed in the network controller 110 and the network nodes 120.

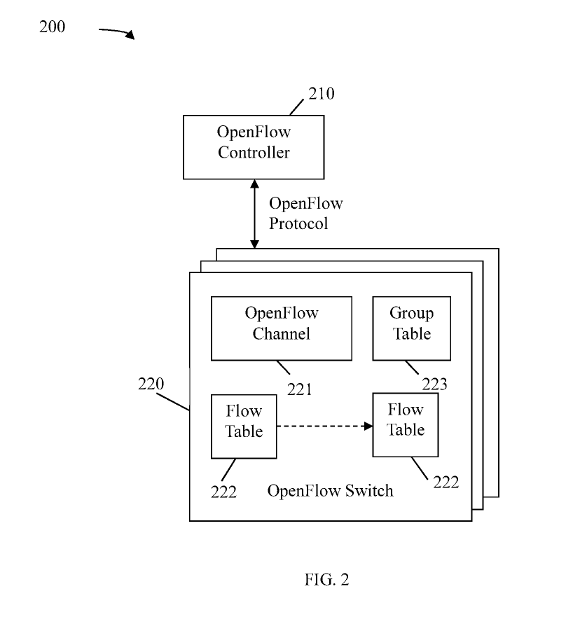

FIG. 2 is a schematic diagram of an embodiment of an OpenFlow network 200 as described in the “OpenFlow Switch Specification version 1.4.0,” Oct. 14, 2013. The network 200 is substantially similar to the system 100 and provides a more detailed view of the controller-switch interactions in the system 100 via the OpenFlow protocol. The network 200 comprises an OpenFlow controller 210 and one or more OpenFlow switches 220. The OpenFlow controller 210 and the OpenFlow switches 220 are similar to the network controller 110 and network nodes 120, respectively. The OpenFlow protocol provides standard application programming interfaces (APIs) for the OpenFlow controller 210 to interact with the OpenFlow switches 220.

Each OpenFlow switch 220 comprises an OpenFlow channel 221 or agent, one or more flow tables 222, and a group table 223. The OpenFlow channel 221 is configured to communicate commands and/or data packets between the OpenFlow controller 210 and the OpenFlow switch 220. In the network 200, the OpenFlow controller 210 sends messages, commands, and/or queries to each OpenFlow switch 220 via the OpenFlow channel 221. Similarly, the OpenFlow controller 210 receives messages, responses, and/or notifications from each OpenFlow switch 220 via the OpenFlow channel 221. For example, the OpenFlow controller 210 is configured to add, update, and/or delete flow entries in a flow table 222. In the OpenFlow protocol, the processing and forwarding of information flows that traverse an OpenFlow switch 220 are specified via the flow table 222, the group table 223, and/or a set of actions that are stored in the flow table 222 and/or the group table 223. The flow table 222 and the group table 223 are also referred to as MATs. A MAT entry comprises a match attribute, an action attribute, and a priority. A matching rule is a set of criteria or match conditions, for example, incoming packet header fields, for recognizing or distinguishing units of information or information flows to be processed by an OpenFlow switch 220. An action operates on units of information, for example, packets or frames, and/or information flows, for example, signals comprising a characteristic that enables them to be distinguished from other signals in an OpenFlow switch 220, such as timeslots or frequency bands. The MATs control packet processing and/or flow pipeline processing. The flow table 222 controls the processing for a particular flow (e.g., unicast packets) and the group table 223 controls the processing for a group of flows (e.g., multicast or broadcast packets). For example, when the OpenFlow switch 220 receives a packet, the OpenFlow switch 220 searches the flow table 222 for a highest-priority entry that matches the received packet and then executes the actions in the corresponding entry. In addition, the flow table 222 may further direct a flow to a group table 223 for further actions.

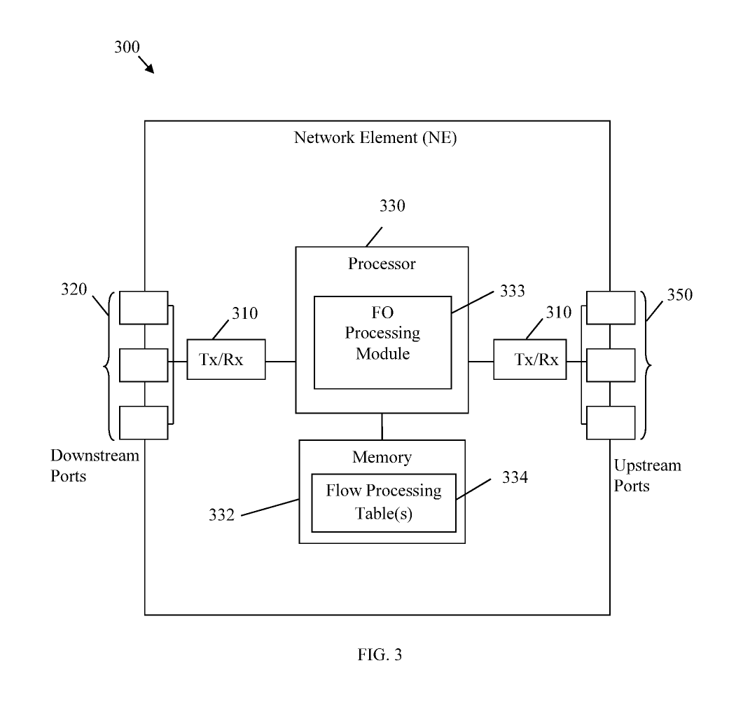

FIG. 3 is a schematic diagram of an embodiment of an NE 300. The NE 300 may act as a node, such as the network node 120 or the OpenFlow switch 220, in an SDN, such as the system 100 or the network 200. The NE 300 may be configured to implement and/or support the complex network control mechanisms described herein. The NE 300 may be implemented in a single node or the functionality of NE 300 may be implemented in a plurality of nodes. One skilled in the art will recognize that the term NE encompasses a broad range of devices of which NE 300 is merely an example. NE 300 is included for purposes of clarity of discussion, but is in no way meant to limit the application of the present disclosure to a particular NE embodiment or class of NE embodiments. At least some of the features and/or methods described in the disclosure may be implemented in a network apparatus or module such as an NE 300. For instance, the features and/or methods in the disclosure may be implemented using hardware, firmware, and/or software installed to run on hardware. As shown in FIG. 3, the NE 300 may comprise transceivers (Tx/Rx) 310, which may be transmitters, receivers, or combinations thereof. A Tx/Rx 310 may be coupled to plurality of downstream ports 320 for transmitting and/or receiving frames from other nodes and a Tx/Rx 310 may be coupled to plurality of upstream ports 350 for transmitting and/or receiving frames from other nodes, respectively. A processor 330 may be coupled to the Tx/Rx 310 to process the frames and/or determine which nodes to send the frames to. The processor 330 may comprise one or more multi-core processors and/or memory devices 332, which may function as data stores, buffers, etc. The processor 330 may be implemented as a general processor or may be part of one or more application specific integrated circuits (ASICs) and/or digital signal processors (DSPs). The processor 330 may comprise an FO processing module 333, which may perform processing functions of a network node 120 or an OpenFlow switch 220 and implement method 900, as discussed more fully below, and/or any other methods discussed herein. In an alternative embodiment, the FO processing module 333 may be implemented as instructions stored in the memory devices 332, which may be executed by the processor 330. The memory device 332 may comprise a cache for temporarily storing content, e.g., a random-access memory (RAM). Additionally, the memory device 332 may comprise a long-term storage for storing content relatively longer, e.g., a read-only memory (ROM). For instance, the cache and the long-term storage may include dynamic RAMs (DRAMs), solid-state drives (SSDs), hard disks, or combinations thereof. The memory device 332 may be configured to store one or more flow processing tables 334, such as the flow tables 222, the group tables 223, and/or any other tables employed by the complex network control mechanisms described herein.

It is understood that by programming and/or loading executable instructions onto the NE 300, at least one of the processor 330 and/or memory device 332 are changed, transforming the NE 300 in part into a particular machine or apparatus, e.g., a multi-core forwarding architecture, having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

Ethernet bridges and switches perform complex network controls, such as CFM, in addition to forwarding Ethernet frames. For example, the Institute of Electrical and Electronics Engineers (IEEE) 802.1Q-2011 document defines a virtual local area network (VLAN) on an Ethernet network, and the IEEE 802.1ag-2007 document defines a CFM protocol for the IEEE 802.1Q Ethernet bridges and switches, which both are incorporated herein by reference. The CFM protocol partitions a network into hierarchical administrative domains, which are referred to as maintenance domains (MDs). MDs may be defined at a core network level, a provider level, or a customer level. Each MD is managed by a single management entity. CFM operations are performed by maintenance points (MPs) which may be grouped in maintenance associations (MAs). MPs are entities that operate in the media access control (MAC) interfaces and/or ports of network nodes, such as the network node 120 and the NE 300. An MP located at a network node positioned at an edge of a MD is referred to as a maintenance endpoint (MEP). An MP located at a network node positioned along a network path within an MD is referred to as a maintenance intermediate point (MIP). MEPs initiate CFM messages and MIPs respond to the CFM messages initiated by the MEPs. An MEP may act as a down MEP or an up MEP. A down MEP is an MEP that monitors CFM operations external to the network node towards a network interface, whereas an up MEP is an MEP that monitors CFM operations internal to the network node.

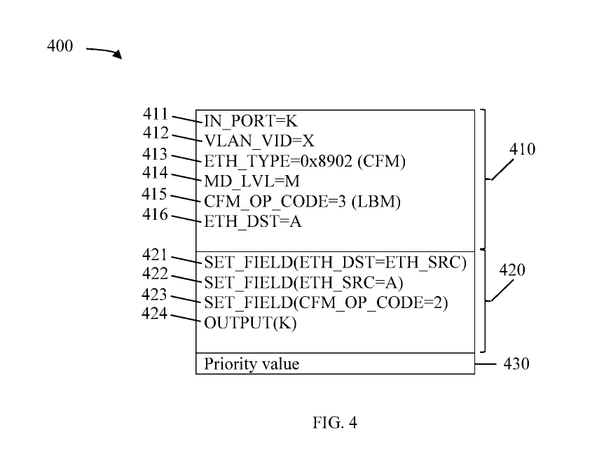

The CFM protocol defines a CC protocol, an LB protocol, and a link trace (LT) protocol that operate together to enable network fault monitoring, detection, and isolation. The CC protocol defines mechanisms for MEPs to monitor connectivity among the MEPs and/or discover other active MEPs operating in the same MD. For example, MEPs operating at the same MD level may exchange CC check messages (CCMs) periodically. The LB protocol defines mechanisms for an MEP to verify the connectivity between the MEP and a peer MEP or MIP. For example, an MEP may send an LB message (LBM) to a peer MEP and the peer MEP may respond with an LB response (LBR). The LT protocol enables an MEP to trace a path to other MEPs and/or MIPs. For example, an MEP may send an LT message (LTM) and all reachable MEPs and/or MIPs respond with an LT response (LTR). FIGS. 4-7 illustrate several approaches to extending the SDN model and the OpenFlow protocol for performing CFM in an SDN, such as the system 100 and the network 200.

FIG. 4 is a schematic diagram of an embodiment of a flow table entry 400 for performing a CFM LB function in an SDN, such as the system 100 and the network 200. For example, the CFM LB function may be similar to the LB protocol described in the IEEE 802.1ag-2007 document. The flow table entry 400 is implemented at a network node, such as the network node 120 and the OpenFlow switch 220. The flow table entry 400 may be installed on the network node by a network controller, such as the network controller 110 and the OpenFlow controller 210, to instruct the network node to perform the CFM LB function. The flow table entry 400 comprises a match attribute 410, an action attribute 420, and a priority attribute 430.

The match attribute 410 comprises a plurality of match conditions 411, 412, 413, 414, 415, and 416 that identify a flow context associated with the CFM LB function in the SDN. The match condition 411 determines if an incoming packet is received from a particular port number K. The match condition 412 determines if the packet is received from a particular VLAN identified by an identifier X. The match condition 413 determines if the packet is a CFM protocol packet, for example, by checking that the packet comprises an Ethernet type field, denoted as ETH_TYPE, indicating a CFM packet type (e.g., ETH_TYPE=0x8902). The match condition 414 determines if the packet is a MD level M packet, for example, by checking that the packet comprises a MD level field, denoted as MD_LVL, indicating a value of M (e.g., MD_LVL=M). The match condition 415 determines if the packet is an LBM, for example, by checking that the packet comprises a CFM operational code field, denoted as CFM_OP_CODE, indicating an LBM operation (e.g., CFM_OP_CODE=3). The match condition 416 determines if the packet is destined to the network node, for example, by checking that the packet comprises an Ethernet destination address field, denoted as ETH_DST, indicating the network node's MAC address. When an incoming packet satisfies the match conditions 411-416 in the match attribute 410, the incoming packet is identified as an LBM destined to a CFM down MEP that operates at an MD level M in a VLAN identified by an identifier X and is located on a port number K.

The action attribute 420 comprises a plurality of actions 421, 422, 423, and 424 that are applied to an incoming packet that satisfies the match conditions 411-416 specified in the match attribute 410. The action attribute 420 instructs the network node to generate and send an LBR. For example, the action 421 instructs the network node to set the ETH_DST field of the LBR to the Ethernet source address field, denoted as ETH_SRC, of the LBM. The action 422 instructs the network node to set the ETH_SRC field of the LBR to the network node's MAC address. The action 423 instructs the network node to set the CFM_OP_CODE field to indicate an LBR (e.g., CFM_OP_CODE=2). The action 424 instructs the network node to forward the LBR to the port at which the LBM is received (e.g., OUTPUT (K)). Thus, when the flow table entry 400 is installed on a network node, the flow table entry 400 causes the network node to act as a CFM down MEP in a VLAN X on a port number K and to perform a CFM LB function at an MD level M.

The priority attribute 430 may comprise a priority value higher than all other flow entries, such as a default flood entry and other flow entries with a VLAN ID value of X and a MAC address of A, configured in the network node. For example, when the network node receives a packet that matches the VLAN ID and the MAC address in multiple flow table entries, the network node selects the flow entry comprising the highest priority value.

In an embodiment, a network controller, such as the network controller 110 and the OpenFlow switch 220, in an SDN, such as the system 100 and the network 200 may send an LBM to a network node, such as the network node 120 and the OpenFlow switch 220, to initiate an LB test as described in the IEEE 802.1ag-2007 document without adding any additional flow entries to the network node. For example, a network controller may send an OpenFlow protocol PACKET_OUT message carrying an LBM.

In another embodiment, the network controller may configure two network nodes, such as the network nodes 120 and the OpenFlow switch 220, in a network, such as the system 100 and the network 200, to act as CFM MEPs and to perform LB functions. For example, the network controller configures a first network node in the network as a first CFM MEP and installs a first flow table entry on the first network node to cause the first network node to initiate LBMs and to monitor for LBRs. Similarly, the network controller configures a second network node in the network as a second CFM MEP and installs a second flow entry similar to the flow table entry 400 on the second network node to cause the second network node to monitor for LBMs and to respond with LBRs.

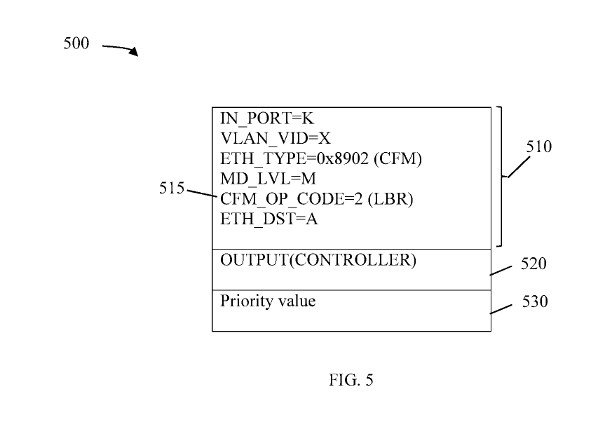

FIG. 5 is a schematic diagram of another embodiment of a flow table entry 500 for performing a CFM LB function in an SDN, such as the system 100 and the network 200. The flow table entry 500 is implemented at a network node, such as the network node 120 and the OpenFlow switch 220. The flow table entry 400 may be installed on the network node by a network controller, such as the network controller 110 and the OpenFlow controller 210, to instruct the network node to perform the CFM LB function. The flow table entry 500 is substantially similar to the flow table entry 400, but enables the network controller to capture LBRs from the network node. The flow table entry 500 comprises a match attribute 510, an action attribute 520, and a priority attribute 530. The match attribute 510 is substantially similar to the match attribute 410, but comprises a match condition 515 that determines if an incoming packet is an LBR instead of an LBM, for example, by checking that the packet comprises a CFM_OP_CODE field indicating an LBR operation (e.g., CFM_OP_CODE=2). The action attribute 520 comprises an action instructing the network node to forward the incoming packet to the network controller (e.g., OUTPUT (CONTROLLER)) upon receiving an LBR. Thus, the network controller may capture LBRs in the SDN.

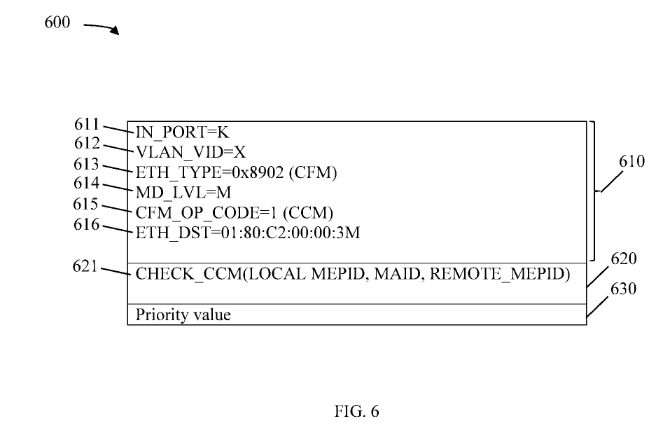

FIG. 6 is a schematic diagram of an embodiment of a flow table entry 600 for performing a CFM CC function in an SDN, such as the system 100 and the network 200. For example, the CFM CC function may be similar to the CC protocol described in the IEEE 802.1ag-2007 document. The flow table entry 600 is implemented at a network node, such as the network node 120 and the OpenFlow switch 220. The flow table entry 600 may be installed on the network node by a network controller, such as the network controller 110 and the OpenFlow controller 210, to instruct the network node to perform the CFM CC function. The flow table entry 600 comprises a match attribute 610, an action attribute 620, and a priority attribute 630. The priority attribute 630 is similar to the priority attribute 430.

The match attribute 610 comprises a plurality of match conditions 611, 612, 613, 614, 615, and 616 that identify a flow context associated with CFM in the SDN. The match conditions 611, 612, 613, and 614 are substantially similar to the match conditions 411, 412, 413, and 414, respectively. The match condition 615 determines if an incoming packet is a CCM, for example, by checking that the packet comprises a CFM_OP_CODE field indicating a CC operation (e.g., CFM_OP_CODE=1). The match condition 616 determines if the packet comprises a CCM multicast destination address (e.g., ETH_DST=01-80-C2-00-00-3M). When an incoming packet satisfies the match conditions 611-616, the incoming packet is identified as a CCM destined to a CFM down MEP that operates at an MD level M in a VLAN identified by an identifier X and is located on a port number K.

The action attribute 620 comprises an action 621 that instructs the network node to perform a CC function, denoted as CHECK_CCM, between a CFM down MEP entity (e.g., identified by an identifier LOCAL_MEPID) implemented at the network node and a remote CFM down MEP entity (e.g., identified by an identifier REMOTE_MEPID) operating in an MA (e.g., identified by an identifier MAID). It should be noted that the CHECK_CCM function is not an OpenFlow protocol defined construct or function. The CHECK_CCM function may implement the CC operations described in the IEEE document 802.1aq. For example, the CHECK_CCM function may comprise setting and/or clearing CC internal state variables. Thus, when the flow table entry 600 is installed on a network node, the flow table entry 600 causes the network node to act as a CFM down MEP in an MA MAID in a VLAN X on a port number K and to perform a CFM CC function at an MD level M.

As described above, a network controller may configure a network node to perform CFM LB and CC by installing flow table entries 400, 500, and/or 600 on the network node. The network controller may also configure the network node to perform CFM LT by employing substantially similar flow table entry configuration mechanisms as described in the FIGS. 4-6. However, since CFM LT is more complex than CFM CC and LB, flow table entries for specifying CFM LT actions may be more complex. In addition to installing the flow table entries, the network controller may send LBMs and/or CCMs to a network node, for example, by employing the PACKET_OUT function defined in the OpenFlow protocol. Since CCMs are periodic messages, the network controller may employ additional mechanisms to determine the CCMs transmission rate. It should be noted the flow table entry 600 identifies a flow for a particular remote MEP. Thus, the network controller may install one flow table entry 600 for each remote MEP that the CFM CC is monitoring. As such, the approach of employing a network controller to configure CFM actions in network nodes may not be efficient.

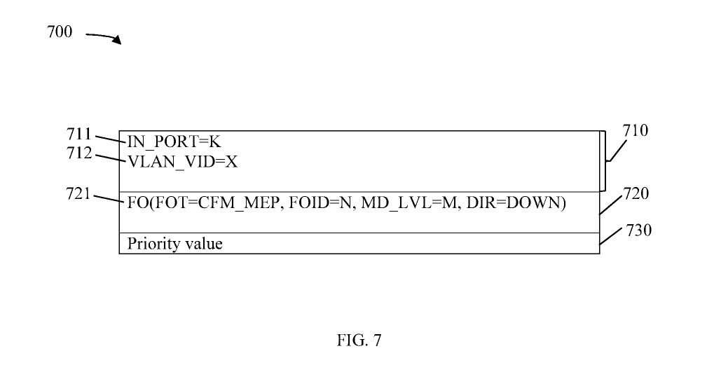

FIG. 7 is a schematic diagram of an embodiment of a flow table entry 700 that employs an FO reference for performing CFM functions in an SDN, such as the system 100 and the network 200. For example, the CFM functions may be similar to the CFM protocol described in the IEEE 802.1ag-2007 document. The flow table entry 700 is implemented at a network node, such as the network node 120 and the OpenFlow switch 220. The flow table entry 700 may be installed on the network node by a network controller, such as the network controller 110 and the OpenFlow controller 210, to instruct the network node to perform the CFM functions. The flow table entry 700 comprises a match attribute 710, an action attribute 720, and a priority attribute 730.

The match attribute 710 comprises a plurality of match conditions 711 and 712 that identifies a flow context in the SDN, where the flow context may include a single flow or a group of flows identified by a set of common match characteristics. The match condition 711 determines if an incoming packet is received from a particular port number K. The match condition 712 determines if the packet is received from a particular VLAN identified by an identifier X.

The action attribute 720 comprises an action 721 that instructs the network node to perform the CFM functions by indicating a reference to an FO of a CFM MEP type (e.g., FOT=CFM_MEP) and an FOID (e.g., FOID=N) that is employed for identifying the FO. The FO is referred to as an MEP FO. As shown in the action 721, the FO reference includes two additional input parameters, an MD level parameter, denoted as MD_LVL, and a direction parameter, denoted as DIR. The MD_LVL parameter indicates an MD level at which the network node is configured to perform the CFM functions (e.g., MD_LVL=M). The DIR parameter indicates a particular direction at which the network node is configured to perform the CFM functions. For example, the DIR parameter is set to a down direction (e.g., DIR=DOWN) to indicate that the network node is configured to act as a CFM down MEP. The FO reference may also include other parameters, such as a maintenance association identifier, an MEP identifier, and/or other initial MEP state values, that define the context of the MEP FO referenced by the FO reference.

When the network node is configured with the action attribute 720, the network node generates an FO according to the FOT and associates the FO with the FOID such that the FO may be subsequently identified by the FOID. The FO comprises a plurality of network behaviors associated with the CFM functions. For example, the network behaviors may include CFM CC functions, CFM LB functions, and CFM LT functions. The network behaviors may be defined and/or implemented by employing several mechanisms. For example, the network behaviors may be represented in the form of a set of MAT entries, function attributes, functional implementations, and/or any other form of constructions. In an embodiment, when the network behaviors are represented in the form of a set of MAT entries, some of the MAT entries may be substantially similar to the flow table entry 400, 500, and/or 600 described above. However, it should be noted that the FO is not part of the flow table entry 700. Thus, when a network controller queries a flow table comprising the flow table entry 700, the reference to the FO is returned to the network controller, but not the FO. However, the FO may comprise internal states and/or variables, which may be read and/or modified upon a query referencing the FOID. Some examples of internal states for a CFM FO may include CCM transmission rate and MEP state as defined in the IEEE 802.1 aq document. In addition, the FO may comprise network behaviors that are independent from the flow pipeline processing. For example, the generation of periodic CCMs may be initiated by timers and not based on packets received from the flow context.

When the flow table entry 700 is installed on a network node, the flow table entry 700 causes the network node to act as a CFM down MEP in a VLAN X on a port number K and to perform CFM functions at an MD level M. In contrast to the flow table entries 400, 500, and 600, the flow table entry 700 does not specify match conditions and/or actions for each individual CFM operation, but instead specify the type of network control and the parameters associated with the network control. The mechanisms described in the flow table entry 700 may be suitable for any well-defined network controls. When the network control type is well-defined, each network node may generate an FO comprising the same network behaviors.

Another example of a well-defined network control that may be performed by a network node is protection switching. Different protection switching schemes may be employed to protect line failures on links, such as the links 131, and node failures on network nodes, such as the network nodes 120 and OpenFlow switch 220, and avoid substantial data loss. Some examples of protection switching protocol may include the optical transport network (OTN) linear protection switching protocol described in International Telecommunication Union Telecommunication (ITU-T) G.873.1 document and the Ethernet linear protection switching protocol described in ITU-T G.808.1 document, which both are incorporated herein by reference.

An example of a protection switching scheme is a 1+1 linear protection scheme. The 1+1 linear protection scheme employs a working path and a protection path for data transfer. The working path carries data to a destination network node and the protection path carries a copy of the data to the destination network node. When the working path fails, the destination node may receive a copy of the data from the protection path. For example, the destination node may apply some criteria to determine whether the data received from the working path is corrupted. To implement a 1+1 protection switching scheme at a network node, such as the network node 120 and the OpenFlow switch 220, the network node is configured with three connection points, a normal connection point, a working connection point, and a protection connection point. The normal connection point carries the data traffic to be protected, the working connection point carries the data traffic to the destination node via the working path, and the protection connection point carries the data traffic to the other end of the protection domain towards the destination node via the protection path. In addition, the network node may employ some tandem connection monitoring (TCM) mechanisms to monitor the conditions of both the working path and the protection path.

To implement protection switching in an SDN, such as the system 100 and the network 200, a network controller may configure flows and actions associated with the three connection points by employing similar mechanisms as described in the flow table entries 400, 500, and 600. However, protection switching is complex and may lead to the same drawbacks with large flow tables and complex match conditions as for the CFM functions. Thus, the method of extending the SDN model and OpenFlow protocol by including FO reference similar to the flow table entry 700 may be more suitable.

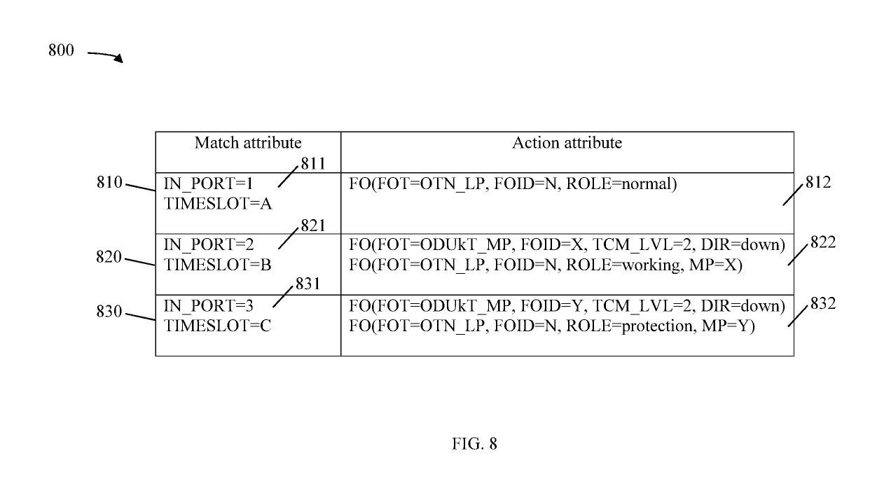

FIG. 8 is a schematic diagram of an embodiment of a portion of a flow table 800 for performing protection switching functions in an SDN, such as the system 100 and the network 200. The flow table 800 is implemented at a network node, such as the network node 120 and the OpenFlow switch 220. The flow table entry 800 may be installed on the network node by a network controller, such as the network controller 110 and the OpenFlow controller 210. For example, the SDN is implemented over an OTN and the network node is configured with three ports or connection points, a normal connection point, a working connection point, and a protection connection point, for performing protection switching. The flow table 800 comprises three flow table entries 810, 820, and 830, each corresponding to one of the connection points. For example, the flow table entry 810 corresponds to the normal connection point, the flow table entry 820 corresponds to the working connection point, and the flow table entry 830 corresponds to the protection connection point.

The flow table entry 810 comprises a match attribute 811 and an action attribute 812. The match attribute 811 comprises a plurality of match conditions for determining whether an incoming packet is received from the normal connection point. For example, the normal connection point is located on port number 1 and associated with data traffic carried in the OTN in timeslots A. The action attribute 812 instructs the network node to perform a protection switching function by indicating a reference to an FO of an OTN linear protection (OTN_LP) type and identified by an FOID, N, where the FO is referred to as a protection switching FO. The action attribute 812 further includes a ROLE parameter to indicate that the OTN linear protection is associated with a normal connection point.

The flow table entry 820 comprises a match attribute 821 and an action attribute 822. The match attribute 821 comprises a plurality of rules for determining whether an incoming packet is received from the working connection point. For example, the working connection point is located on port number 2 and associated with data traffic carried in the OTN in timeslots B. The action attribute 822 instructs the network node to perform a TCM function by indicating a reference to an FO of an ODUkT_MP type and identified by an FOID, X, where the ODUkT_MP type represents a tandem monitoring MP for an optical data unit of level K. The FO is referred to as a monitoring FO. The FO reference includes two additional parameters, a TCM level (TCM_LVL) parameter and a DIR parameter, associated with the ODUkT_MP type. The TCM_LVL parameter indicates a particular TCM level at which the network node is configured to perform the TCM function (e.g., TCM_LVL=2). The DIR parameter indicates a particular direction at which network node is configured to perform the TCM function. For example, the DIR parameter is set to a down direction (e.g., DIR=DOWN) to indicate that the network node is configured to act as a down maintenance point (MP) (e.g., towards the network interface). The action attribute 822 further instructs the network node to perform protection switching operations by indicating a reference to the same protection switching FO as referenced by the action attribute 812 by referring to the same FOID N. However, the action attribute 812 sets the ROLE parameter to indicate a working connection point and the protection switching FO reference includes an additional maintenance point (MP) parameter for the working connection point. It should be noted that the MP parameter is set to the same value, X, as the FOID referencing the monitoring FO to enable the monitoring FO and the protection switching FO to exchange information, such as signal fail state and signal degrade state, for monitoring and detecting failures in the working path.

The flow table entry 830 comprises a match attribute 831 and an action attribute 832. The match attribute 831 comprises a plurality of rules for determining whether an incoming packet is received from the protection connection point. For example, the protection connection point is located on port number 3 and associated with data traffic carried in timeslots C. The action attribute 832 is substantially similar to the action attribute 822. For example, the action attribute 832 comprises a reference to a monitoring FO, but an FOID Y is employed for identifying the monitor FO instead of FOID X. Thus, the network node generates a separate monitoring FO for the protection connection point. The action attribute 832 further comprises a reference to the same protection switching FO as in the action attributes 812 and 822, but sets the ROLE parameter to indicate a protection connection point and sets the MP parameter to indicate an MP identifier Y. Similar to the action attribute 822, the protection switching FO reference includes an MP parameter set to the same value, Y, as the monitoring FO's FOID.

In an embodiment, the protection switching FO represents an OTN 1+1 linear protection switching function as described in the ITU-T G.873.1 document, May 2014. The protection switching FO may be referenced by multiple match contexts, such as a normal connection point, a working connection point, and a protection connection point, as described more fully below. The protection switching FO may comprise internal state variables as defined in the ITUT G.873.1 document. The internal state variables may be read and write (R/W) accessible or read-only (R) accessible. The following table lists some examples of protection switching OF internal state variables:

TABLE 1
Protection Switching FO Internal State Variables

| State Variables | Access | Descriptions |
|---|---|---|
| OFState | R | State of the protection switching OF. |
| Dir | R/W | Direction of the protection operation. |
| Aps | R/W | Automatic protection switching (APS) protocol |
| Revert | R/W | Revertive protection switching mode |
| WTRtime | R/W | Wait time for reverting to a working path after the working path is |
| | | restored from failure |
| req_state | R/W | Fault conditions, external commands, or state of the protection |
| | | process |

For example, the OFState state variable may be set to OK to indicate that the protection switching function is successfully installed between the three connection points, the normal connection point, the working connection point, and the protection connection point referencing the protection switching OF. The OFState state variable may be set to INCOMPATIBLE to indicate that the protection switching function fails to connect to the three connection points or the three connection points may be incompatible. The OFState state variable may be set to INCOMPLETE to indicate that the protection switching OF is not referenced by three distinct match contexts, the working connection point is not associated with a valid maintenance point, or the protection connection is not associated with a valid maintenance point.

The Dir state variable may be set to bi-directional or unidirectional. The Aps state variable may be set to true to indicate that an APS protocol is supported by the protection switching FO or false to indicate that the APS protocol is not supported by the protection switching FO. The Revert state variable may be set to true to indicate that revertive protection switching mode is supported by the protection switching FO or false to indicate that revertive protection switching is not supported by the protection switching FO. The req_state state variable may be set to values as described in the ITU-T G.873.1 document, for example, to indicate a lockout state, a force switch state, a manual switch state, a wait-to-restore (WTR) state, a do-not-revert (DNR) state, an exercise state, a non-request state, or a freeze state.

In an embodiment, the monitoring FO may represent a combination of optical data unit of level K tandem connection sublayer (ODUkT), optical data unit of level K adaptation (ODUk_A), and optical data unit layer (ODUk_TT) functions as described in the ITU-T G.798 document, December 2014. In such an embodiment, the monitoring FO may include internal state variables as shown below, where the internal state variables are as described in the ITU-T G.798 document:

TABLE 2
Monitoring FO Internal State Variables

| State | | |
|---|---|---|
| Variables | Access | Descriptions |
| TxTI | R/W | Trail trace to transmit in the ODU tandem |
| | | overhead |
| ExSAPI | R/W | Expected source access point identifier |
| ExDAPI | R/W | Expected destination access point identifier |
| TIMDetMo | R/W | Trail trace identifier mismatch detection |
| | | mode |
| DEGThr | R/W | Degraded defect one-second erroneous |
| | | block count threshold |
| DEGM | R/W | Degraded defect consecutive one-second |
| | | monitoring intervals |
| AcTI | R | Accepted trail trace identifier |
| TSF | R | Trail signal fail |
| TSD | R | Trail signal degraded |

As shown above, CFM and protection switching may be performed in an SDN, such as the system 100 and the network 200, by extending the SDN model and the OpenFlow protocol to include FO extensions. When a network node, such as the network node 120 and the OpenFlow switch 220, is configured with an action attribute, such as the action attributes 720, 812, 822, and 832, comprising an FO reference indicating an FOID and an FOT, the network node generates an FO of the FOT, where the FO is identified by the FOID. The FO reference may further include additional parameters depending on the FOT. The generated FO may be referenced by multiple action attributes and may be queried or set by referencing the FOID. It should be noted that the generation of an FO is equivalent to instantiating an instance of the FO and the network node generates a single FO instance for each FOID.

FOs may be deleted via two mechanisms, implicit deletion or explicit deletion. For example, when all FO references are removed from a flow table, such as the flow tables 222 and 800, the network node implicitly deletes the FO. Alternatively, the FO may be explicitly deleted when a deletion action or a deletion command references the FO.

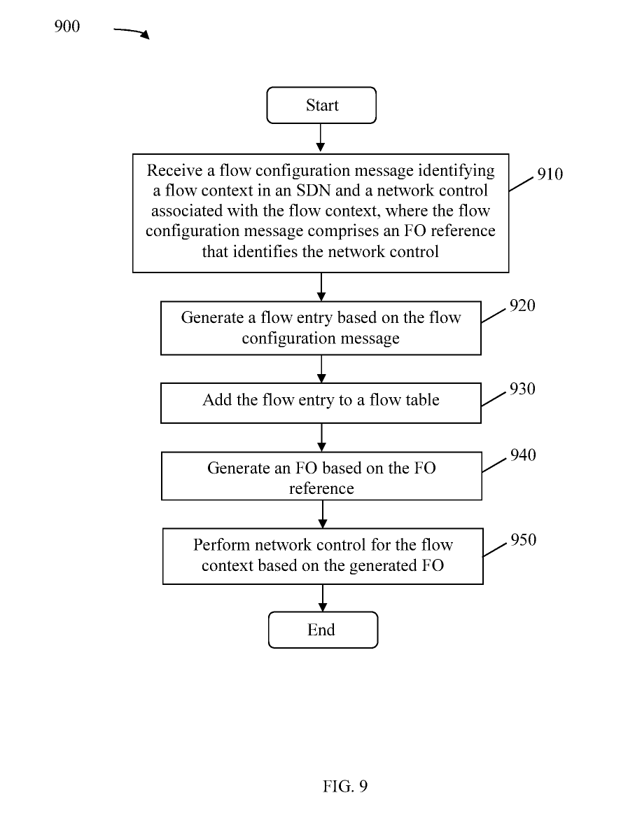

FIG. 9 is a flowchart of an embodiment of a method 900 for performing network control in an SDN, such as the system 100 and the network 200. The method 900 is implemented by a network node, such as the network node 120, the OpenFlow switch 220, and the NE 300. The method 900 is implemented when the network node receives a flow configuration message that includes a network control for a flow context in the SDN. At step 910, a flow configuration message identifying a flow context in an SDN and a network control associated with the flow context is received by the network node. For example, the flow configuration message provides a matching rule for identifying the flow context and an FO reference for identifying the network control. The matching rule comprises a set of criteria or match conditions, for example, based on packet header fields and ingress port. The FO reference comprises an FOT that identifies the network control and an FOID that is employed for referencing an FO that performs the network control. The flow configuration message may be received from a network controller, such as the network controller 110 and the OpenFlow switch 220. At step 920, a flow entry is generated based on the flow configuration message. For example, the flow entry may comprise a match attribute that stores the match condition for identifying the flow context and an action attribute that stores the FO reference for identifying the network control. At step 930, the flow entry is added to a flow table, for example, employed by the network node for processing flows in the SDN.

At step 940, an FO is generated based on the FO reference, for example, triggered by the adding of the flow entry comprising the FO reference in the action attribute. The generated FO comprises a plurality of network behaviors associated with the network control. For example, when the network control is the IEEE 802.1ag CFM protocol, the network behaviors in the FO may include the LB, CC, and LT mechanisms as described in the IEEE 802.1ag-2007 document. Alternatively, when the network control is the ITU-T G.873.1 protection switching protocol, the network behaviors in the FO may include the protection switching mechanisms as described in the ITU-T G.873.1 document.

At step 950, the network control is performed for the flow context based on the FO generated by the network node. For example, when the network node receives a packet from the SDN, the network node searches the flow table for a matching entry that comprises a match condition satisfied by the received packet. When the matching entry is found, the network node refers to the action attribute of the matching entry for instructions on processing the received packet. Since the action attribute comprises an FO reference, the network node refers to the FO referenced by the FO reference for performing the network control.

In an embodiment, the FO reference comprises an FOID and an FOT, where the FOID identifies the FO and the FOT identifies the network control. The FO reference may comprise one or more configuration parameters for configuring the network control in the flow context. The FO may comprise one or more internal states, which may be read and/or modified by an external command by referencing the FOID. In some embodiments, at least one of the network behaviors included in the FO is initiated independently from the flow context, for example, by a timer or other external events.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method implemented in a network element (NE), comprising:
receiving a flow configuration message identifying a flow context in a software-defined network (SDN) and a network control associated with the flow context, wherein the flow configuration message comprises a function object (FO) reference that identifies the network control;
generating an FO based on the FO reference, wherein the FO comprises a plurality of network behaviors associated with the network control; and
performing the network control for the flow context based on the FO generated by the NE.

2. The method of claim 1, wherein the FO reference comprises an FO identifier (FOID) and an FO type (FOT), wherein the network control is identified by the FOT, and wherein generating the FO based on the FO reference comprises:
generating the plurality of network behaviors based on the FOT; and
associating the FOID with the FO such that the FOID identifies the FO.

3. The method of claim 2, wherein the FO comprises an internal state variable associated with the network control, wherein the method further comprises:
receiving a request to read the internal state variable from the FO, wherein the request identifies the FO by referencing the FOID; and
sending a response comprising the internal state variable in response to the request.

4. The method of claim 2, wherein the FO comprises an internal state variable, and wherein the method further comprises:
receiving a command to modify the FO's internal state variable, wherein the command identifies the FO by referencing the FOID; and
modifying the FO's internal state variable according to the command in response to the command.

5. The method of claim 2, further comprising:
receiving a deletion message referencing the FOID; and
deleting the FO in response to the deletion message.

6. The method of claim 2, further comprising:
generating a flow table comprising a plurality of flow entries, wherein each flow entry comprises an action attribute; and
adding a flow entry in the flow table, wherein the flow entry identifies the flow context, and wherein the action attribute of the flow entry references the FO by the FOID.

7. The method of claim 6, wherein the FO is referenced by another action attribute associated with a different flow context in the SDN.

8. The method of claim 6, wherein at least two of the action attributes in the flow table reference the FOID, and wherein the method further comprises:
removing all action attributes referencing the FO from the flow table; and
deleting the FO when all the action attributes referencing the FO are removed from the flow table.

9. The method of claim 6, wherein the flow table is an OpenFlow protocol flow table.

10. The method of claim 1, wherein the flow configuration message comprises a parameter for configuring the network control in the flow context.

11. The method of claim 1, further comprising receiving a plurality of packets from the flow context in the SDN, wherein at least one of the network behaviors causes the network control to be performed based on an event independent from the packets received from the flow context.

12. The method of claim 1, wherein the network control is associated with an operation, administration, management (OAM) operation, and wherein the plurality of network behaviors comprise a connectivity fault management (CFM) function, a protection switching function, a tandem connectivity monitoring (TCM) function, or combinations thereof.

13. A computer program product comprising computer executable instructions stored on a non-transitory computer readable medium such that when executed by a processor causes a network element (NE), positioned in a software-defined network (SDN) to:
receive a flow configuration message from a network controller, wherein the flow configuration message comprises a flow entry that identifies a flow context in the SDN, and wherein the flow entry comprises a function object identifier (FOID) and a function object type (FOT) that identify a network control associated with the flow context;
add the flow entry to a flow table, wherein adding the flow entry to the flow table causes an implicit instantiation of a function object (FO) based on the FOID and the FOT, wherein the FO comprises a plurality of network function attributes for performing the network control, and wherein the FOID identifies the FO; and
perform the network control for the flow context based on the FO generated by the NE.

14. The computer program product of claim 13, wherein the flow table comprises more than one action attributes referencing the FO by the FOID.

15. The computer program product of claim 14, wherein the instructions further cause the processor to:
remove all action attributes referencing the FO from the flow table; and
delete the FO upon removing all the action attributes that reference the FO.

16. The computer program product of claim 13, wherein the FO comprises a plurality of internal state variables that are accessible by referencing the FOID.

17. The computer program product of claim 13, wherein the plurality of network function attributes is represented by a match-action table (MAT).

18. A network element (NE) comprising:
a receiver configured to receive a flow configuration message from a network controller, wherein the flow configuration message comprises a flow entry that identifies a flow context in the SDN and a network control associated with the flow context, and wherein the flow entry comprises a function object (FO) reference associated with the network control;
a memory coupled to the receiver and configured to store a flow table; and
a processor coupled to the memory and the receiver and configured to:
update the flow table with the flow entry;
generate an FO for the FO reference based on the network control when the flow entry is updated, wherein the FO comprises a plurality of network behaviors associated with the network control; and
perform the network control for the flow context based on the FO generated by the NE.

19. The NE of claim 18, wherein the FO reference comprises an FO identifier (FOID) and an FO type (FOT), wherein the network control is identified by the FOT, and wherein the processor is further configured to generate the FO based on the FO reference by:
generating the plurality of network behaviors based on the FOT; and
associating the FOID with the FO such that the FOID identifies the FO.

20. The NE of claim 18, wherein the receiver is further configured to receive a plurality of packets from the flow context, and wherein the processor is further configured to perform the network control by initiating at least one of the network behaviors in the FO based on an event independent from the packets received from the flow context.
